(19) United States
(12) Patent Application Publication
(10) Pub. No.: US 2013/0228617 A1
(43) Pub. Date: Sep. 5, 2013

(54) SYSTEM OF USING MACHINE READABLE LABELS AFFIXED TO TOOLS FOR MANAGING INFORMATION RELATED TO THOSE TOOLS

(71) Applicant: Patricia Lynn O'Brien, Washington, MI (US)

(72) Inventor: Patricia Lynn O'Brien, Washington, MI (US)

(21) Appl. No.: 13/690,097

(22) Filed: Nov. 30, 2012

Related U.S. Application Data
(60) Provisional application No. 61/605,366, filed on Mar. 1, 2012.

(51) Int. Cl. G06K 7/10

(52) U.S. Cl. CPC G06K 7/10544
USPC 235/375

(57) ABSTRACT

A system of tracking tool information includes affixing a machine readable label, such as a barcode, such that the label doesn't interfere with tool functionality. This allows tool manufacturers to provide information about the tool, such as specifications, recalls, recommended hours of usage, liens and so forth, with that information “following” the tool. Authorized users can scan the barcode, log into a website, upload the scanned barcode, and view or edit the associated information.

### RELATED APPLICATIONS

This claims the benefit of U.S. Provisional Patent Application 61/605,366, filed Mar. 1, 2012.

### FIELD OF THE INVENTION

The present invention relates to systems using machine readable labels on tools. More specifically it is a system of using machine readable labels, such as barcodes, that are integrated with, or affixed to, molds and dies, or other assets used in the manufacturing of product, thereby permitting a user to access critical information related to that specific tool.

### BACKGROUND OF THE INVENTION

Tools such as molds and dies are used to manufacture products such as plastic parts formed by injection molding. In order to use a given tool properly, the operator must possess certain information about the tool. Such critical information might include the tool manufacturer, process parameters, construction drawings, dimensional information and useful life of the tool. Often times these tools are sent from one plant to another, but critical information related to the tool is not provided, is incomplete, or is lost. This can be very problematic in a manufacturing setting where multiple tools are used, as it is not necessarily easy to distinguish one tool from another by mere inspection. It can be time consuming to perform the investigative work required to determine the identity of a specific tool, or even wasteful or dangerous if a misidentified tool is inadvertently used.

As can be seen, there is a need for a system that allows a tool manufacturer to provide critical tool information that is essentially inseparable from the tool itself. It is desirable that this information does not affect the performance of the tool, and that it is easily readable by the tool operator. It is also desirable that this information be dynamic insofar as it can be updated by the tool operator or agent thereof.

### SUMMARY OF THE INVENTION

A system of using machine readable labels affixed to tools for managing information related to those tools uses components such as barcodes, processors, and barcode readers. A specially created and unique barcode is created when a user creates a profile for a specific tool. This barcode is affixed to a tool in such a manner that the barcode does not interfere with using the tool. The barcode preferably has additional human-readable printing which directs a user to a website. By accessing the website and scanning the barcode on the specific tool, a user is able to access pertinent information related to that tool. Optionally, authorized users may also be able to update information related to that tool. In this manner, manuals, specifications and so forth that are associated with the tool can't be lost or misplaced. Examples of pertinent information includes specifications, recalls, recommended hours of usage, liens and so forth.

### BRIEF DESCRIPTION OF THE DRAWINGS

FIG. 1 represents a tool with a QR-type barcode affixed, with various embodiment depicted in exploded view in FIGS. 1A-1D;

FIG. 2 depicts a UPC-type barcode inscribed directly on a tool, with the barcode shown in an exploded view in FIG. 2A;

FIG. 3 schematically represents some components of an embodiment; and

FIG. 4 schematically represents some features of an embodiment, with FIG. 4A representing a user interface for inputting information, FIG. 4B representing a plaque on a tool, and FIG. 4C representing a user interface for querying information.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structures are found among the various FIGS.:

10—System

12—Barcode

13—Barcode plate

15—Tool

20—Plaque

25—Barcode reader

30—Processor

35—Output display

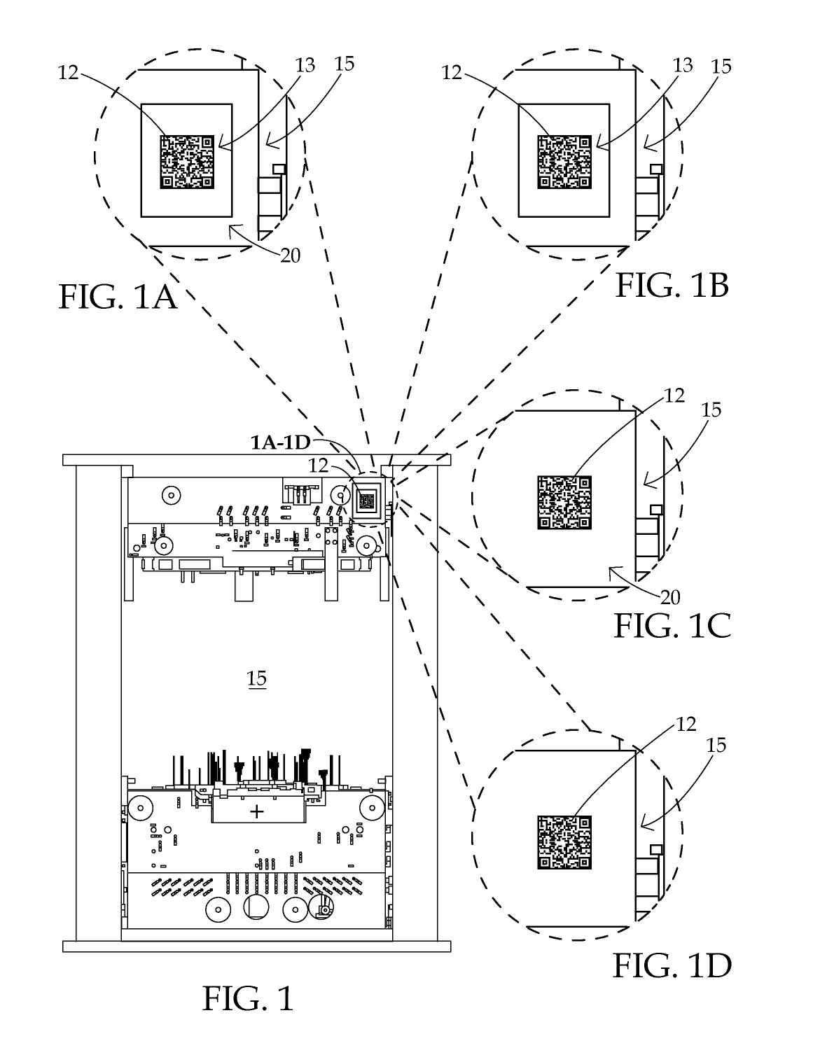

Referring to FIG. 1, information management system 10 includes barcode 12 attached to tool 15. As used herein, a “tool” is a device, machine or apparatus that is portable and used in the manufacture of goods and products. Examples of “tools” include tool and dies, molds, controllers, machines, fixtures, hot runner systems, and secondary equipment.

As shown in FIG. 1A, barcode 12 may be situated on barcode plate 13, which is affixed to plaque 20, with plaque 20 attached to tool 15. In this manner barcode plate 13 is not directly attached to tool 15, as plaque 20 is sandwiched between.

In this embodiment it is desirable that barcode plate 13 substrate is aluminum, steel, with barcode 12 markings effectuated by printing, etching, laser imprinting, and inscribing. It is desirable that surface of barcode plate 13 has approximate dimensions of 2.75″ by 3.5″ to 8″ by 10″ with approximately 2.75″×3.5″ being more desirable, and approximately 3″×5″ being most desirable. Thickness of barcode plate 13 is desirably approximately 1 mm to 3 mm with approximately 1 mm being more desirable.

It is desirable plaque 20 substrate is aluminum and/or steel with surface dimensions of approximately 2.75″ by 3.5″ to 9″ by 11″ with approximately 3″×3.75″ being more desirable, and approximately 3.5″×5.5″ being most desirable. Thickness of plaque 20 is desirably approximately 1 mm to 3 mm with 1 mm being preferred. It is desirable that plaque 20 is slightly larger than barcode plate 13.

Attachment of the various components, including barcode plate 13 and plaque 20 to tool 15, should be substantially permanent, yet not interfere with the operation of the tool. For example, in the case of a tool and die, barcode plate 13 and plaque 20 should be attached to the fixed (non-moving) portion of tool 15. Attachment of barcode plate 13 and plaque 20 to tool 15 can be effectuated by a variety of methods including adhesion, welding, bolting

In an alternative embodiment, shown in FIG. 1B, barcode 12 is situated on barcode plate 13, which is attached directly to tool 15. In other words there is no plaque 20. In yet another embodiment, shown in FIG. 1C, plaque 20 is inscribed with barcode 12, which is attached to tool 15. In other words, there is no barcode plate 13.

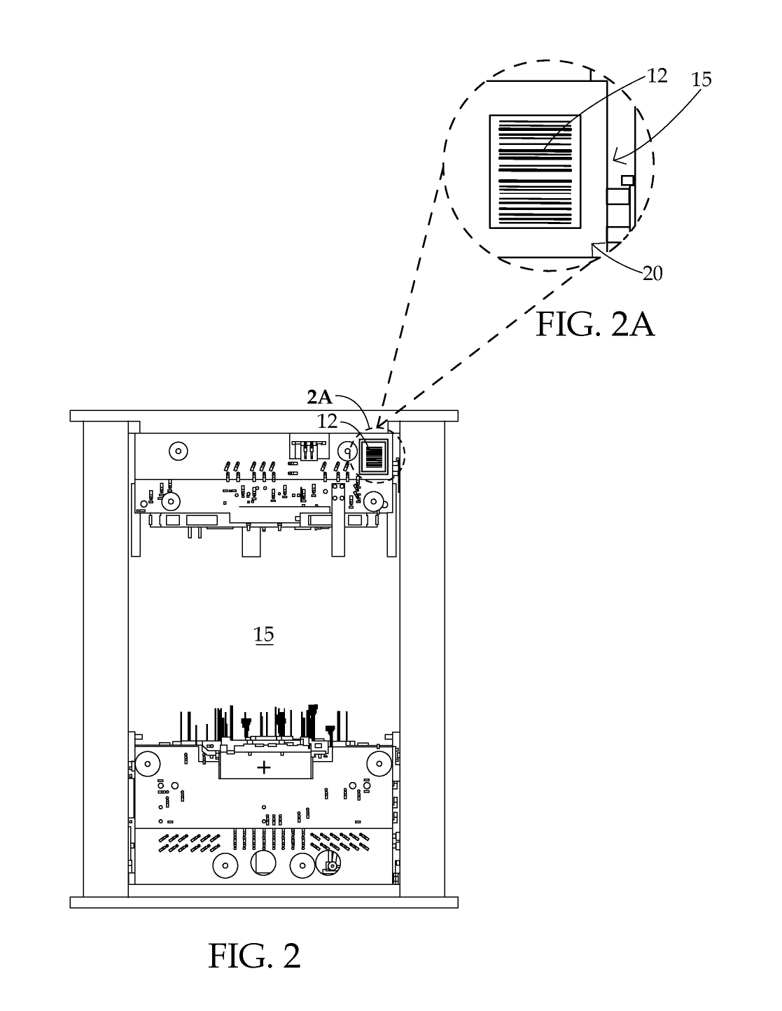

Turning now to FIG. 2, it is also within the scope of this invention to situate the barcode directly onto tool 15. In this embodiment there is no plaque 20 and no barcode plate 13. Such inscription can be by etching, engraving, laser engraving or the like.

A variety of barcode symbologies can be used, for example matrix (2D) such as QR, or linear (1D) such as UPC, as shown in FIGS. 1 and 2 respectively.

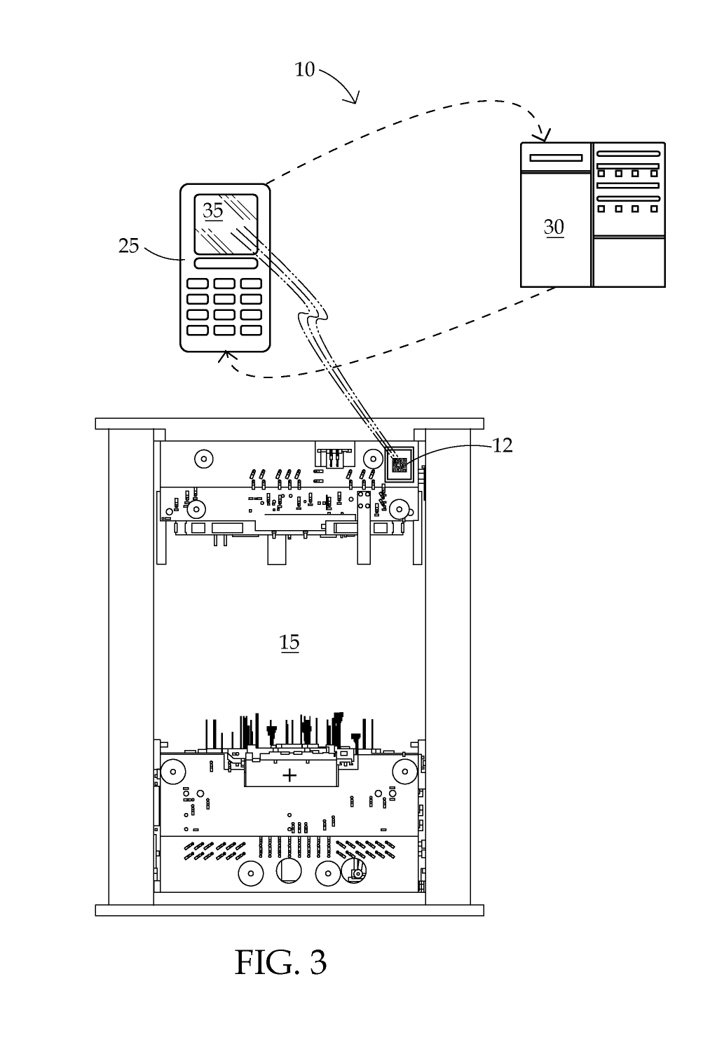

An overview of the system is schematically depicted in FIG. 3, wherein system 10 generally includes tool 15 having barcode 12; a barcode reader 25; an output display 35; and a processor 30. A user wanting critical information related to tool 15 would use barcode reader 25 to scan barcode 12. Reader 25 can be a variety of devices including a designated scanner, such as a conventional fixed light and photosensor device (not shown), or a so called “smart phone” with the appropriate application such as “Scan” or “mbarcode”, as shown. Reader 25 transmits a query to processor 30 for information linked to barcode 12, and processor 30 transmits critical information to reader 25, for user's viewing through output display 35. Output display 35 may be included with barcode reader 25, for example a smart phone. This embodiment is depicted in FIG. 3. Processor 30 may be a web server, cloud computing server, tablets, smartphones, wireless devices, or other data processing and/or storage device.

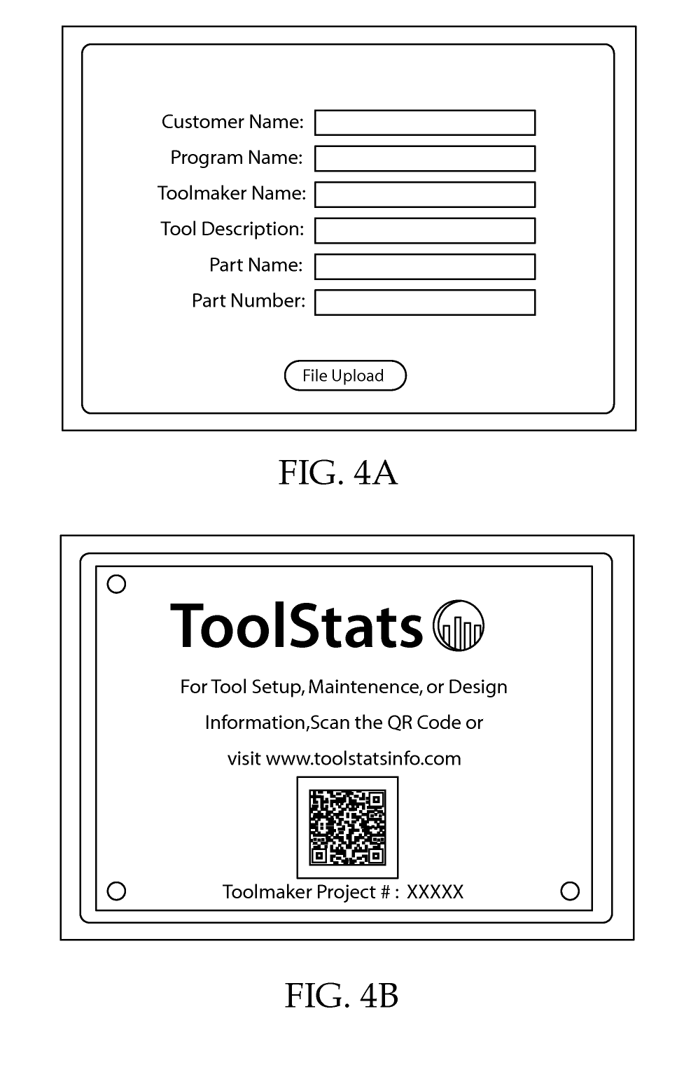

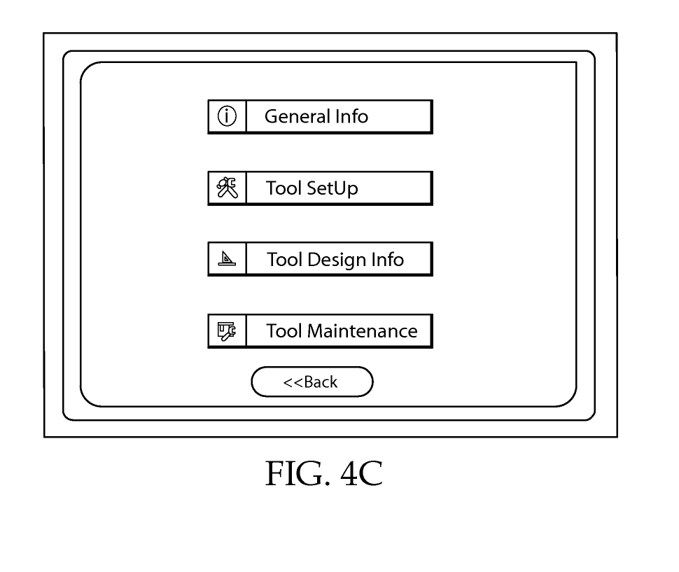

An embodiment and method of using the system is depicted in greater detail in FIG. 4. FIG. 4A is a sample user interface that a user would enter information into so as to register a tool which has not yet been registered. Other relevant information that could be useful in registering a tool includes date of manufacture, warranty information, authenticity of tool, tool set up, design information, and tool maintenance. Upon successfully entering information into the system, as set forth in FIG. 4A, a user receives, preferably by mail, a plaque including the associated barcode. This is depicted in FIG. 4B. The plaque is preferably printed or otherwise marked so as to direct future tool users to a website to query or update information linked to the tool. A subsequent tool user could obtain or update information about the tool by scanning the barcode and accessing the website which is identified on the plaque of FIG. 4B, which would take them to a user interface such as that set forth in FIG. 4C. From there the user could obtain or update a variety of information.

One advantage of system 10 is that critical information related to tool 15 can be updated as necessary, including corrections to specifications, additional safety warnings, messages that a tool is subject to a lien, or that the useful life of a tool is coming to an end. Such an update would be entered into processor 30, so subsequent barcode reader 25 queries would yield this additional information on output display 35. It should be noted that a variety of information can be associated with each tool, and should not be construed to be limited to that which is specifically set forth herein.

It should be understood, of course, that the foregoing relates to exemplary embodiments of the invention and that modifications may be made without departing from the spirit and scope of the invention as set forth in the following claims. By way of example, modifications considered include setting up for maintenance intervals creating alarms to wireless devices announcing time for tool maintenance, changes, or tear down reviews. It should also be understood that ranges of values set forth inherently include those values, as well as all increments between.

What is claimed is:

1. A system for substantially permanently linking information to a device, said system including:
a. a tool;
b. a barcode connected to said tool, said barcode including machine-readable data;
c. a barcode reader for inputting said machine-readable data; and
d. a processor for translating said machine-readable data.

2. The system of claim 1 wherein said tool is a mold and die.

3. The system of claim 1 further including a barcode plate in direct contact with said barcode.

4. The system of claim 1 further including a plaque in direct contact with said tool.

5. The system of claim 1 further including an output display for presenting translated machine-readable data.

6. The system of claim 5 wherein said output display is integrated with said barcode reader.

7. A method of managing information including the steps of:
a. Affixing a unique barcode to a product, said barcode including machine-readable information about said product, said machine-readable information stored on a processor;
b. Providing said product with said barcode to a user for integration of said product into a machine;
c. Directing said user to access a website, said website communicatively coupled to said processor;
d. Directing said user to scan said barcode with a bar scanner, and to upload said barcode to said website; and
e. Providing information about said product to said users, said information provided by said processor and displayed on said bar scanner.

8. The method of claim 7 wherein said step of affixing a unique barcode to a product includes the step of affixing a unique barcode wherein said machine-readable information is unique to said product.

9. The method of claim 7 wherein said step of affixing a unique barcode to a product includes the step of selecting a location on said product which will not interfere with the function of said machine.

10. A method of tracking tool-related information including the steps of:
a. Providing information about a tool, said information routed to a processor;
b. Receiving a unique barcode which is associated with said information;
c. Affixing said barcode to said tool;
d. Scanning said barcode with a barcode reader; and
e. Displaying said information.

11. The method of claim 10 wherein said step of providing information about a tool includes providing information selected from tool manufacturer; tool manufacture date; tool construction specifications;
tool usage specifications; liens on the tool; and tool ownership.

12. The method of claim 10 wherein said step of receiving the unique barcode includes receiving the unique barcode by mail.

13. The method of claim 10 wherein said step of affixing said barcode includes affixing selected from welding, adhering, and bolting.

14. The method of claim 10 wherein the step of displaying the information includes the step of displaying the information on said barcode reader.

15. The method of claim 10 further including the step of updating said information.
